(19) United States
(12) Patent Application Publication
(10) Pub. No.: US 2020/0220375 A1
(43) Pub. Date: Jul. 9, 2020

(54) POWER SUPPLY CIRCUIT FOR SUPPLYING POWER TO MICROCONTROLLER UNIT

(71) Applicant: SENGLED CO., LTD., Shanghai (CN)

(72) Inventor: Zhenfeng DING, Shanghai (CN)

(21) Appl. No.: 16/338,568

(22) PCT Filed: Dec. 7, 2017
(86) PCT No.: PCT/CN2017/114926

§ 371 Date: Apr. 1, 2019

(30) Foreign Application Priority Data
Dec. 23, 2016 (CN) 201611207567.1

(51) Int. Cl. H02J 7/34; H02J 9/06; G08B 21/18

(52) U.S. Cl. CPC H02J 7/345; G08B 5/36; G08B 21/182; H02J 9/061

(57) ABSTRACT

A power supply circuit for supplying power to a microcontroller unit (MCU) comprises: a MCU, a MCU power supply module coupled to the MCU, a load, and a charging capacitor coupled to two ends of the load. The MCU power supply module is coupled to an input power source, and the MCU power supply module is coupled to the charging capacitor via a MOS tube. The MOS tube is coupled to a parasitic diode. The charging capacitor supplies power to the load when the input power source is turned on, and supplies power to the MCU via the parasitic diode and the MCU power supply module when the input power source is turned off

### CROSS-REFERENCES TO RELATED APPLICATIONS

This application is a national phase entry under 35 U.S.C. § 371 of PCT Patent Application No. PCT/CN2017/114926, filed on Dec. 7, 2017, which claims the priority of Chinese Patent Application No. 201611207567.1 filed on Dec. 23, 2016, the entire content of which is incorporated herein by reference.

### FIELD OF THE DISCLOSURE

The present disclosure generally relates to the technical field of power supply and, more particularly, relates to a power supply circuit for supplying power to a microcontroller unit (MCU).

### BACKGROUND

A microcontroller unit (MCU) is also referred to as a single-chip microcomputer or a microcontroller, and is often configured to provide different combined control in different application scenarios.

In existing technologies, a MCU is often coupled to a MCU power supply module, and when the input power source is turned on, the MCU power supply module may supply power to the MCU continuously. When the input power source is turned off, the MCU power supply module may utilize the electrical energy stored in itself to provide temporary power supply to the MCU. However, because of the limited electrical energy storage capacity, the MCU power supply module cannot guarantee long-time operation of the MCU, which reduces the operational stability and reliability of the MCU.

### BRIEF SUMMARY OF THE DISCLOSURE

The present disclosure provides a power supply circuit for supplying power to a microcontroller unit (MCU), thereby solving at least partial of the aforementioned issues or other issues in existing technology.

The disclosed power supply circuit for supplying power to the MCU may include: a MCU, a MCU power supply module coupled to the MCU, a load, and a charging capacitor coupled to two ends of the load. The MCU power supply module is coupled to an input power source, and the MCU power supply module may be further coupled to the charging capacitor via a metal oxide semiconductor (MOS) tube. The MOS tube, also referred to as MOS transistor, is coupled to a parasitic diode.

The charging capacitor may be configured for supplying power to the load when the input power source is turned on. When the input power source is turned off, the charging capacitor may be configured for supplying power to the MCU via the parasitic diode and the MCU power supply module.

The aforementioned power supply circuit may further include: a control module coupled to the MOS tube. The control module may be further coupled to the MCU power supply module and the charging capacitor. The control module may be configured for controlling the MOS tube to be turned on when the input power source is turned on, such that the charging capacitor may supply power to the load. Further, when the input power source is turned off, the control module may control the MOS tube to be turned off, such that the charging capacitor may supply power to the MCU via the parasitic diode and the MCU power supply module.

The aforementioned power supply circuit may further include: a filter/rectifier module coupled between the MCU power supply module and the input power source. The filter/rectifier module may also be coupled to the control module.

In the aforementioned power supply circuit, one end of the charging capacitor may be coupled to the control module, and the other end of the charging capacitor may be coupled to the control module via a diode.

In the aforementioned power supply circuit, the charging capacitor may be coupled to a source electrode of the MOS via an inductor and a resistor.

In the aforementioned power supply circuit, the diode is coupled to the source electrode of the MOS tube via the resistor.

In the aforementioned power supply circuit, the MOS tube may be a P-channel MOS tube.

In the aforementioned power supply circuit, the control module may be configured for acquiring the capacitance of the charging capacitor, the voltage between two ends of the load, the working current of the MCU, and an efficiency of the power supply. Based on the capacitance of the charging capacitor, the voltage between the two ends of the load, the working current of the MCU, and the efficiency of the power supply, the control module may determine the sustainable operation time of the MCU. Further, based on the sustainable operation time, the control module may control the power supply circuit.

The aforementioned power supply circuit may further include an alarm module coupled to the control module. When the sustainable operation time is shorter than or equal to a pre-configured threshold, the control module may control the alarm module to be triggered.

In the aforementioned power supply circuit, the alarm module may include: a LED bulb and/or a beeper.

By using the power supply circuit provided by the present disclosure to supply power to a MCU, a MCU power supply module is coupled to a charging capacitor via a MOS tube, and the MOS tube is coupled to a parasitic diode. Accordingly, when an input power source is turned on, the charging capacitor may effectively supply power to a load, and when the input power source is turned off, the charging capacitor may supply power to the MCU via the parasitic diode and the MCU power supply module. Thus, the operation time of the MCU after the input power source is turned off is elongated, which ensures the operational stability and reliability of the MCU and effectively improves the practicability of the power supply circuit, thereby facilitating the application and market promotion of the disclosed power supply circuit.

### BRIEF DESCRIPTION OF THE DRAWINGS

To more clearly illustrate the technical solutions in embodiments of the present disclosure, the accompanying drawings of the present disclosure are briefly introduced hereinafter. Obviously, the accompanying drawings merely provide certain exemplary implementations, based on which, other drawings or implementations may be obtainable by those ordinarily skilled in the art without creative effort.

FIG. 1 illustrates a structural schematic view of a power supply circuit for supplying power to a MCU consistent with embodiments of the present disclosure; and

FIG. 2 is a schematic diagram illustrating a connection between a control module and an alarm module consistent with embodiments of the present disclosure.

In the drawings:

1. MCU

2. MCU power supply module

3. Load

4. Charging capacitor

5. MOS tube

6. Parasitic diode

7. Control module

8. Filter/rectifier module

9. Inductor

10. Diode

11. Resistor

12. Alarm module

1201. Beeper

1202. LED bulb

### DETAILED DESCRIPTION

With reference to the accompanying drawings of the present disclosure, technical solutions of the present disclosure are described more fully hereinafter. Obviously, the described embodiments only provide some exemplary implementations. Based on the disclosed embodiments, other embodiments obtainable by those ordinarily skilled in the relevant art without creative labor shall all fall within the protection scope of the present disclosure.

Terms such as “first”, “second”, “third”, and “fourth”, etc. (if exists) in the specification, claims, and the aforementioned accompanying drawings are used to differentiate similar objects, and may not necessarily used to illustrate specific order or sequence. It should be understood that data used in such way may be exchanged under proper situations, thus allowing the disclosed embodiments described herein to be implemented in other orders than that illustrated or described here. Further, terms of “comprising” and “including” and any their derivatives are intended to cover non-excluding inclusions. For example, a process, method, system, product or device comprising a series of steps or units are not necessarily limited to those clearly listed steps or units, but may include steps or units not clearly listed, or other steps or units intrinsic to such process, method, product or device.

With reference to specific embodiments, technical solutions of the present disclosure are illustrated in detail hereinafter. The specific embodiments below may be combined with each other, and the same or similar concepts or processes are not repeatedly described in certain embodiments.

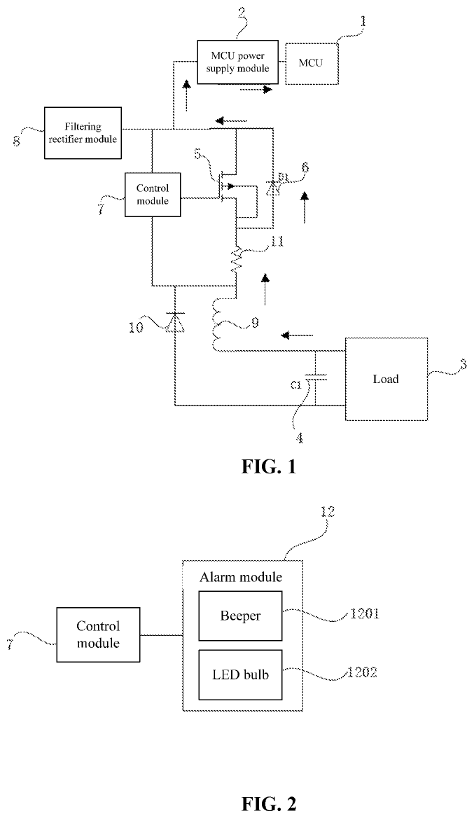

FIG. 1 illustrates a structural schematic view of a power supply circuit for supplying power to a MCU consistent with embodiments of the present disclosure. Referring to FIG. 1, the power supply circuit may include a MCU 1, a MCU power supply module 2, a load 3, a charging capacitor 4, a MOS tube 5, and a parasitic diode 6 (also denoted as D1). The capacitance of the charging capacitor 4 may be denoted as C1. Optionally, the power supply circuit may further include a control module 7, a filter/rectifier module 8, an inductor 9, a diode 10, and a resistor 11.

More specifically, the MCU 1 may be coupled to the MCU power supply module 2, and the charging capacitor 4 may be coupled to two ends of the load 3. The MCU power supply module 2 may access an input power source for receiving power from the input power source. Further, the MCU power supply module 2 may be coupled to the charging capacitor 4 via the MOS tube 5. The MOS tube 5 may be coupled to the parasitic diode 6, for example, the MOS tube 5 may be connected in parallel with the parasitic diode 6.

The charging capacitor 4 may be configured for supplying power to the load 3 when the input power source is turned on. Further, when the input power source is turned off, the charging capacitor 4 may supply power to the MCU 1 via the parasitic diode 6 and the MCU power supply module 2. The specific type of the load 3 is not limited and may be configured by those skilled in the art based on specific designing demands. For example, the load 3 may be configured to be a lamp, a computer, or a smart home appliance, etc.

In some embodiments of the present disclosure, the power supply circuit described in relation to FIG. 1 may be integrated into the load 3. For example, a lamp may include a driver circuit with a power supply circuit as described in FIG. 1. A smart appliance may include a driver circuit with a power supply circuit as described in FIG. 1.

Further, the specific type of the MOS tube 5 is not limited, and those ordinarily skilled in the art may configure the type of the MOS tube 5 based on specific needs. For example, the MOS tube 5 may be configured to be an N-channel MOS tube or a P-channel MOS tube.

In one embodiment, the MOS tube 5 may be coupled between the MCU power supply module 2 and the load 3 without the parasitic diode 6 being coupled to the MOS tube 5. In another embodiment, the parasitic diode 6 may be coupled to the MOS tube 5, and by coupling the parasitic diode 6 to the MOS tube 5, the parasitic diode 6 may undergo reverse breakdown to guide a large current to ground before an overvoltage V_{DD} of the high-power MOS tube 5 is damaged.

By coupling the parasitic diode 6 to the MOS tube 5, the occurrence of the MOS tube 5 being burned may be avoided. Further, the parasitic diode 6 may prevent the MOS tube 5 from being damaged when the source electrode and the drain electrode of the MOS tube 5 are connected reversely. Or, when a reverse-induced voltage exists in the circuit, the parasitic diode 6 may provide a path for the reverse-induced voltage to avoid the breakdown of the MOS tube 5 caused by the reverse-induced voltage, such that the operational stability and reliability of the MOS tube 5 in the power supply circuit may be effectively ensured.

In one embodiment, the power supply circuit may further include the control module 7 coupled to the MOS 5, and the control module 7 may improve the practicability of the power supply circuit when the power supply circuit is utilized to supply power. The control module 7 may be coupled between the MCU power supply module 2 and the charging capacitor 4. Thus, when the input power source is turned on, the control module 7 may control the MOS tube 5 to be turned on for enabling the charging capacitor 4 to supply power to the load 3, and when the access to the input power source is cut off, the control module 7 may control the MOS tube 5 to be turned off, such that the charging capacitor 4 may supply power to the MCU 1 via the parasitic diode 6 and the MCU power supply module 2.

In one embodiment, the power supply circuit may further include the filter/rectifier module 8 disposed between the MCU power supply module 2 and the input power source, and the filter/rectifier module 8 may be configured for ensuring the efficiency and quality of power supply of the input power source. The filter/rectifier module 8 may be further coupled to the control module 7. The filter/rectifier module 8 may be configured for wave-filtering and rectifying of the input signal of the input power source, thereby ensuring the power supplying quality and efficiency of the input power source.

The specific shape or structure of the filter/rectifier module 8 is not specifically limited, and those skilled in the art may configure the filter/rectifier 8 based on desired functions or effects. For example, the filter/rectifier module 8 may be a filter/rectifier circuit including inductors and capacitors.

More specifically, when the input power source is turned on, after the input signal of the input power source is processed by the filter/rectifier module 8, a channel of electric signal may supply power to the MCU 1 via the MCU power supply module 2. Further, the control module 7 may control the MOS tube 5 to be turned on, such that another channel of electric signal from the input power source may charge the charging capacitor 4. In such situation, the charging capacitor 4 may further supply power to the load 3.

Further, the input power source may be turned off. When the input power source is turned off, the control module 7 may control the MOS tube to be turned off, and the electrical energy stored in the charging capacitor 4 may supply power to the MCU 1 via the parasitic diode 6 and the MCU power supply module 2. Accordingly, the operational stability and reliability of the MCU 1 may be ensured.

As such, in the disclosed power supply circuit that supplies power to the MCU 1, the MCU power supply module 2 is configured to be coupled to the charging capacitor 4 via the MOS tube 5, and the MOS tube 5 is coupled to the parasitic diode 6. When the input power source is turned on, the charging capacitor 4 may effectively supply power to the load 3, and when the input power source is turned off, the charging capacitor 4 may supply power to the MCU 1 via the parasitic diode 6 and the MCU power supply module 2.

Thus, the operation time of the MCU 1 after the input power source is turned off may be elongated, which ensures the operational stability and reliability of the MCU 1, and effectively improves the practicability of the power supply circuit, such that the application and market promotion of the disclosed power supply circuit may be facilitated.

Based on the aforementioned descriptions, referring to FIG. 1, the inductor 9 and the diode 10 may be included in the power supply circuit to further improve the operational stability and reliability of the power supply circuit. More specifically, one end of the charging capacitor 4 may be coupled to the control module 7 via the inductor 9, and the other end of the charging capacitor 4 may be coupled to the control module 7 via the diode 10.

Further, a connection manner between the charging capacitor 4 and the MOS tube 5 is not specifically limited. In one embodiment, the charging capacitor 4 may be connected to a source electrode of the MOS tube 5 via the inductor 9 and the resistor 11. More specifically, the inductor 9 may be configured for enabling the direct current (DC) to flow through and impeding the alternating current (AC), and the resistor 11 may be configured for current limiting. Thus, the stability and reliability of the charging capacitor 4 for power supply to the MCU 1 may be ensured.

Under such situations, when the input power supply is turned off, the charging capacitor that is charged may supply power to the MCU 1 specifically via the inductor 9, the resistor 11, the parasitic diode 6, and the MCU power supply module, as indicated by the arrows in FIG. 1.

To further improve the operational stability and reliability of the power supply circuit, the diode 10 may be further coupled to the source electrode of the MOS tube 5 via the resistor 11. Under such situation, the diode 10 is disposed in parallel with a branch of the circuit where the inductor 9 and the charging capacitor 4 are disposed. Thus, similar to the branch of the circuit that includes the inductor 9 and the charging capacitor 4, the diode 10 is coupled between the load 3 and the control module 7 and between the load 3 and the MOS tube 5. Optionally, an anode of the diode 10 may be connected to ground to provide a voltage-stabilizing function, thus further ensuring the safety and operational reliability of the power supply circuit.

FIG. 2 is a schematic diagram illustrating a connection between a control module and an alarm module consistent with the present disclosure. As shown in FIG. 2, the power supply circuit may further include an alarm module 12, and the alarm module 12 may be coupled to the control module 7 to enable the power supply circuit to have an alerting function. The alarm module 12 may, for example, include a beeper 1201, and a LED bulb 1202.

Referring to FIG. 1 and FIG. 2, the control module 7 may be configured for acquiring capacitance of the charging capacitor 4, a voltage between two ends of the load 3, a working current of the MCU 1, and an efficiency of the power supply. Based on the capacitance of the charging capacitor 4, the voltage between two ends of the load 3, the working current of the MCU 1, and the efficiency of the power supply, the control module 7 may determine the sustainable operation time of the MCU. Further, based on the sustainable operation time, the control module 7 may be configured to control the power supply circuit.

For example, the capacitance of the charging capacitor 4 may be obtained from user input and stored in the control module 7 for further use. Or, related parameters of the charging capacitor 4 may be acquired to calculate the capacitance of the charging capacitor 4. The efficiency of power supply may be pre-configured or may be inputted by the user to the control module 7.

More specifically, based on the capacitance of the charging capacitor 4, the voltage between two ends of the load 3, the working current of the MCU 1, and the efficiency of the power supply, the sustainable operation time of the MCU 1 may be determined using a following equation:

$$t = \frac{\frac{1}{2} {C}_{1} \times {U}_{1}^{2} \times η}{I}$$

Where, t represent the sustainable operation time of the MCU 1, I represent the working current of the MCU 1, C₁ represents the capacitance of the charging capacitor 4, U₁ represents the voltage between two ends of the load 3, and η represents the efficiency of power supply.

It should be noted that ½C₁×U₁² is equal to the total energy Qₜ (also referred to as the total electric quantity) that the charging capacitor 4 may stores after being fully charged. When the charging capacitor 4 is utilized to charge the MCU 1, energy dissipation exists, such that the energy received by the MCU 1 from the charging capacitor 4 may be expressed as: Q_{MCU1}=Qₜ×η. Further, by dividing the energy received by the MCU 1, i.e., Q_{MCU1}, by the working current of the MCU 1, the sustainable operation time of the MCU 1 may be calculated.

In existing technologies, when the input power source is turned off, and only the MCU power supply module 2 is applied to supply power to the MCU 1, the sustainable operation time t′ may be expressed as:

$${t}^{′} = \frac{{Q}_{M C U}}{I} = \frac{{C}_{2} \times {U}_{2}}{I} ,$$

where C₂ represents output capacitance of the MCU power supply module 2, U₂ represents the power supply voltage of the MCU 1. To make the sustainable operation time of the MCU 1 upon receiving power supply from the MCU power supply module 2 to be equal to the sustainable operation time of the MCU 1 upon receiving the power supply from the charging capacitor 4, that is,

$$\frac{{C}_{2} \times {U}_{2}}{I} = \frac{\frac{1}{2} {C}_{1} \times {U}_{1}^{2} \times η}{I} ,$$

the output capacitance C₂ of the MCU power supply module 2 may be expressed using the capacitance C₁ of the charging capacitor 4 as follows:

$${C}_{2} = \frac{\frac{1}{2} {C}_{1} \times {U}_{1}^{2} \times η}{{U}_{2}} .$$

Based on the relationship between the output capacitance of the MCU power supply module 2 and the charging capacitor 4, given a specific application scenario in which U₂=3.3V, U₁=36V, and η=0.9, it is obtained that C₂=176×C₁. That is, in the example of the specific application scenario, to make the sustainable operation time of the MCU 1 upon receiving power supply from the MCU power supply module 2 to be equal to the sustainable operation time of the MCU 1 upon receiving the power supply from the charging capacitor 4, the output capacitance C₂ of the MCU power supply module 2 needs to be 176 times the capacitance C₁ of the charging capacitor 4.

Thus, by applying the power supply circuit provided by the present disclosure, under the condition that the sustainable operation time of the MCU 1 remains constant, the dimension occupied by the power source board for the power supply circuit may be reduced. Further, the cost of the power supply circuit for MCU 1 may be lowered.

Further, the alarm module 12 may be coupled to the control module 7 to ensure the operational quality and efficiency of the power supply circuit. When the sustainable operation time is shorter than or equal to a preset threshold, the control module 7 may control the alarm module 12 to be triggered.

The specific shape and structure of the alarm module 12 are not limited, and those skilled in the art may configure the shape and structure of the alarm module based on specific designing demands. For example, the alarm module 12 may include a LED bulb 1202 and/or a beeper 1201. Or, the alarm module 12 may include a plurality of LED bulbs 1202, or a plurality of beepers 1201, or any combination thereof

In one embodiment, when the alarm module 12 includes one or more LED bulbs 1202, when the sustainable operation time is shorter than or equal to the pre-configured threshold, the control module 7 may control the one or more LED bulbs 1202 to flicker on and off, thereby notifying the user or the staff that the sustainable operation time of the power supply circuit is very short. Thus, the user and the staff may timely adjust or maintain the power supply circuit.

In another embodiment, the alarm module 12 may include one or more beepers 1201, and when the sustainable operation time is shorter than or equal to the threshold, the control module 7 may control the beeper 1201 to send out an alarming sound, a song, an audio message, etc., thereby notifying the user or the staff that the sustainable operation time of the power supply circuit is very short.

In another embodiment, the alarm module 12 may include a plurality of LED bulbs and a beeper 1201. Under such situation, when the sustainable operation time is shorter or equal to the threshold, the control module 7 may control the plurality of LED bulbs 1202 to flicker and the beeper 1201 to beep. Accordingly, the user or the staff may be notified both visually and acoustically that the sustainable operation time of the power supply circuit is very short, which ensures the alerting effect that the alarm module 12 provides. Accordingly, the operational stability and reliability of the power supply circuit may be further ensured.

The present disclosure may further provide a power supply apparatus, comprising an input power source, and any aforementioned power supply circuit. Repeated descriptions are not provided herein and may refer to the above-described embodiments.

Various embodiments in the specification are described in a progressive manner, and each embodiment highlights their difference from other embodiments, and the same or similar parts between each embodiment may refer to each other.

In various embodiments of the present disclosure, it should be understood that the disclosed method, device and apparatus may be implemented by other manners. For example, the device described above is merely for illustrative. For example, the units may be merely partitioned by logic function. In practice, other partition manners may also be possible. For example, various units or components may be combined or integrated into another system, or some features may be omitted or left unexecuted. Further, mutual coupling or direct coupling or communication connection displayed or discussed there between may be via indirect coupling or communication connection of some communication ports, devices, or units, in electrical, mechanical or other manners.

Units described as separated components may or may not be physically separated, and the components serving as display units may or may not be physical units. That is, the components may be located at one position or may be distributed over various network units. Optionally, some or all of the units may be selected to realize the purpose of solutions of embodiments herein according to practical needs. Further, each functional module in each embodiment of the present disclosure may be integrated in one processing unit, or each module may exist physically and individually, or two or more modules may be integrated in one processing unit.

When the described functions are implemented as software function units, and are sold or used as independent products, they may be stored in a computer accessible storage medium. Based on such understanding, the technical solutions of the present disclosure, or the portions contributing to the prior art may be embodied in the form of a software product. The computer software product may be stored in a storage medium, and include several instructions to instruct a computer device (e.g., a personal computer, a server, or a network device) to execute all or some of the method steps of each embodiment. The storage medium described above may include portable storage device, ROM, RAM, a magnetic disc, an optical disc or any other media that may store program codes.

Those skilled in the relevant art may clearly understand that for ease and clear description, the division of the aforementioned functional modules are for illustrative purposes, and in practical applications, the aforementioned functions may be fulfilled by different functional modules based on needs. That is, the internal structure of the device may be divided into different functional modules to fulfill all or partial functions illustrated in the foregoing descriptions.

Finally it should be illustrated that, those embodiments above are only used to illustrate technical solutions of the present disclosure, but not to limit the scope of the disclosure. Though, referring to previous embodiments, the present disclosure is illustrated in details, those ordinarily skilled in the art may still understand that the disclosed technical solutions may be modified, or either partial or entire technical characteristics may be equally exchanged. Via such modification or exchange, the nature of the corresponding technical solutions will not depart from the principles of the present disclosure.

What is claimed is:

1. A power supply circuit for supplying power to a microcontroller unit (MCU), comprising:
the MCU;
a MCU power supply module coupled to the MCU;
a load; and
a charging capacitor coupled to two ends of the load,
wherein the MCU power supply module is coupled to an input power source,
the MCU power supply module is further coupled to the charging capacitor via a metal oxide semiconductor (MOS) tube,
the MOS tube is coupled to a parasitic diode, and
the charging capacitor is configured to supply power to the load when the input power source is turned on and to supply power to the MCU via the parasitic diode and the MCU power supply module when the input power source is turned off

2. The power supply circuit according to claim 1, further comprising:
a control module coupled to the MOS tube,
wherein the control module is coupled between the MCU power supply module and the charging capacitor,
when the input power source is turned on, the control module is configured to control the MOS tube to be turned on to enable the charging capacitor to supply power to the load, and
when the input power source is turned off, the control module is configured to control the MOS tube to be turned off, thereby enabling the charging capacitor to supply power to the MCU via the parasitic diode and the MCU power supply module.

3. The power supply circuit according to claim 2, further comprising:
a filter/rectifier module coupled between the MCU power supply module and the input power source, wherein the filter/rectifier module is further coupled to the control module.

4. The power supply circuit according to claim 2, wherein:
one end of the charging capacitor is coupled to the control module via an inductor, and
another end of the charging capacitor is coupled to the control module via a diode.

5. The power supply circuit according to claim 4, wherein:
the charging capacitor is coupled to a source electrode of the MOS tube via the inductor and a resistor.

6. The power supply circuit according to claim 5, wherein:
the diode is coupled to the source electrode of the MOS tube via the resistor.

7. The power supply circuit according to claim 1, wherein:
the MOS tube is a P-channel MOS tube.

8. The power supply circuit according to claim 2, wherein:
the control module is configured to acquire capacitance of the charging capacitor, a voltage between two ends of the load, a working current of the MCU, and an efficiency of power supply,
based on the capacitance of the charging capacitor, the voltage between two ends of the load, the working current of the MCU, and the efficiency of power supply, the control module determines a sustainable operation time, and
based on the sustainable operation time, the control module controls the power supply circuit to operate.

9. The power supply circuit according to claim 8, further comprising:
an alarm module coupled to the control module,
wherein in response to the sustainable operation time being shorter than or equal to a pre-configured threshold, the control module controls the alarm module to be triggered.

10. The power supply circuit according to claim 9, wherein:
the alarm module comprises at least one of an LED bulb and a beeper.

11. A power supply apparatus, comprising:
a power source; and
a power supply circuit for supplying power to a MCU,
wherein the power supply circuit includes:
the MCU,
a MCU power supply module coupled to the MCU,
a load, and
a charging capacitor coupled to two ends of the load,
wherein the MCU power supply module is coupled to an input power source,
the MCU power supply module is further coupled to the charging capacitor via a metal oxide semiconductor (MOS) tube,
the MOS tube is coupled to a parasitic diode, and
the charging capacitor is configured to supply power to the load when the input power source is turned on and to supply power to the MCU via the parasitic diode and the MCU power supply module when the input power source is turned off

12. The power supply apparatus according to claim 11, wherein:
the power supply circuit further comprises:
a control module coupled to the MOS tube,
wherein the control module is coupled between the MCU power supply module and the charging capacitor,
when the input power source is turned on, the control module is configured to control the MOS tube to be turned on to enable the charging capacitor to supply power to the load, and
when the input power source is turned off, the control module is configured to control the MOS tube to be turned off, thereby enabling the charging capacitor to supply power to the MCU via the parasitic diode and the MCU power supply module.

13. The power supply apparatus according to claim 12, wherein:
the power supply circuit further comprises:
a filter/rectifier module coupled between the MCU power supply module and the input power source, wherein the filter/rectifier module is further coupled to the control module.

14. The power supply apparatus according to claim 12, wherein:
the control module is configured to acquire capacitance of the charging capacitor, a voltage between two ends of the load, a working current of the MCU, and an efficiency of power supply,
based on the capacitance of the charging capacitor, the voltage between two ends of the load, the working current of the MCU, and the efficiency of power supply, the control module determines a sustainable operation time, and
based on the sustainable operation time, the control module controls the power supply circuit to operate.
